(19) United States
(12) Patent Application Publication
(10) Pub. No.: US 2009/0106849 A1
(43) Pub. Date: Apr. 23, 2009

(54) Portable Computer

(76) Inventor: Hengning Wu, Bristow, VA (US)

Correspondence Address: HENGNING WU;Acroscape, 12923 Roberts Ridge CT., Bristow, VA, 20136, US

(21) Appl. No.: 12/344,528

(22) Filed: Dec. 28, 2008

(51) Int. Cl. H04L 9/32; G09G 5/00; G06F 3/041; G06F 3/033

(52) U.S. Cl. 726/28; 345/1.3; 345/173; 345/157

(57) ABSTRACT

A portable computer, comprising a first display screen in the portrait format housed in a first panel and a second display screen in the landscape format housed in a second panel. The second panel is physically attached to the first panel, and the diagonal size of the second display screen is 40% to 70% of the diagonal size of the first display screen. The effective size of the display area is larger than the physical area of the display screens, and the portable computer can have small size, light weight, and long battery life.

### BACKGROUND OF INVENTION

The present invention relates to a portable computer and specifically relates to the display screen of a portable computer. A portable computer may be called a laptop computer, a notebook, a netbook, a handheld computer, or an ultra-portable computer in the industry.

The design of a portable computer is a tradeoff between portability and functionality. For portability, the computer needs to be light, small, and slim. A typical notebook computer weighs about 3 kilograms, and has a display screen with a diagonal size from 12 inches to 17 inches. The battery life is typically around 3 hours. An ultra-portable computer may weigh about one kilogram and have a display screen of 6.4 inches to 13.5 inches. A handheld computer may have a display screen of 2.5 inches to 6.4 inches. The display screen in this specification means a general purpose display screen. Auxiliary display screens may be used in portable computers for special purposes such as computer status, time, or short information. They are typically LED screens with predefined characters and symbols or very small screens with diagonal sizes less than 2 inches or display areas less than 2 square inches. For functionality, it is desirable to have a large display screen and a long battery life. When the size of display screen is increased, the computer size and power consumption will increase. This will lead to either a short battery life, or an increase in weight for the additional battery power.

### SUMMARY OF INVENTION

One object of the present invention is to increase the effective display area without the corresponding increase in the physical area of display. As the power consumption for display is proportional to the physical display area, the effective power consumption will be not as large as for a large size screen. Therefore, the computer can maintain the small size, light weight, and long battery life, which are desirable for browsing the internet and reading books, magazines, newspapers, documents, and emails.

Another object of the present invention is to use the display area effectively to achieve better performance and reduce power consumption.

Still another object of the present invention is to provide an ergonomical design of the portable computer for convenient operation and aesthetic appearance.

According to one aspect of the invention, the portable computer has two display screens of different sizes. The first display screen is on one panel of the portable computer, and the second display screen is on the other panel of the portable computer. The effective screen size is the rectangle enclosing the two display screen. The optimum size for the second display screen can be calculated from the aspect ratio of the screens. Generally, the diagonal size of the second display screen is 40% to 70% of the diagonal size of the first display screen.

According to another aspect of the invention, the two display screens can be turned off independently. When one screen is not in use, it can be turned off or put at the standby mode to save electric power consumption.

According to another aspect of the invention, the first display screen is electronic paper. The first display screen can be used for texts and documents. The second display screen can be used for video and graphic display. The electronic paper display has a very low power consumption and is viewable under bright light. The second display screen can also be a touch screen for input. Since the touch screen is small, this will reduce the computation power needed.

According to another aspect of the invention, the first display screen is in the portrait (vertical) format, and the second display screen is in the landscape (horizontal) format. The portrait format is more suitable for texts and documents, while the landscape format is more suitable for pictures and videos. This combination of two formats functions equivalently to a much larger display screen. The keyboard, the control buttons, and the pointing devices are conveniently located for easy access and operation. The two panels can be open vertically to accommodate the reading habit and the feelings of a conventional book.

According to another aspect of the invention, the computer is locked with a digital identity. Therefore, the computer is secured from theft of its contents. On the other hand, this facilitates the access to copyrighted digital materials.

### BRIEF DESCRIPTION OF DRAWINGS

FIG. 1 shows the portable computer of the present invention.

FIG. 2 shows the effective display area of the present invention.

FIG. 3 shows the single panel computer of the present invention.

### DETAILED DESCRIPTION

Many portable computers, commonly known as notebook computers, are constructed as two panels: a rotating or hinging panel and a fixed base panel. The rotating panel housing a display screen typically pivots or rotates with respect to the base of the computer. The fixed base panel often includes input/output devices such as a keyboard and a touch pad. The fixed base panel also houses a central processing unit and other computer hardware. The two panels are pivotally connected so that the first panel can be folded on to the second panel like a book. A typical notebook computer weighs about 3 kilograms, and has a display screen with a diagonal size from 12 inches to 17 inches. The battery life is typically around 3 hours. A small version of notebook, also called netbook, is lighter and smaller, with a typical weight around one kilogram and a typical display screen of 8.9 inches. An ultra-portable computer may weigh about one kilogram and have a display screen of 6.4 inches to 13.5 inches. For example, Macbook Air® by Apple Inc, Cupertino, Calif., U.S.A., gets a reasonably large 13.3-inch (diagonal) widescreen (display with a weight of 1.36 kilograms (3 pounds), but the battery life is not as long as the ultra-portable computers with smaller screen sizes.

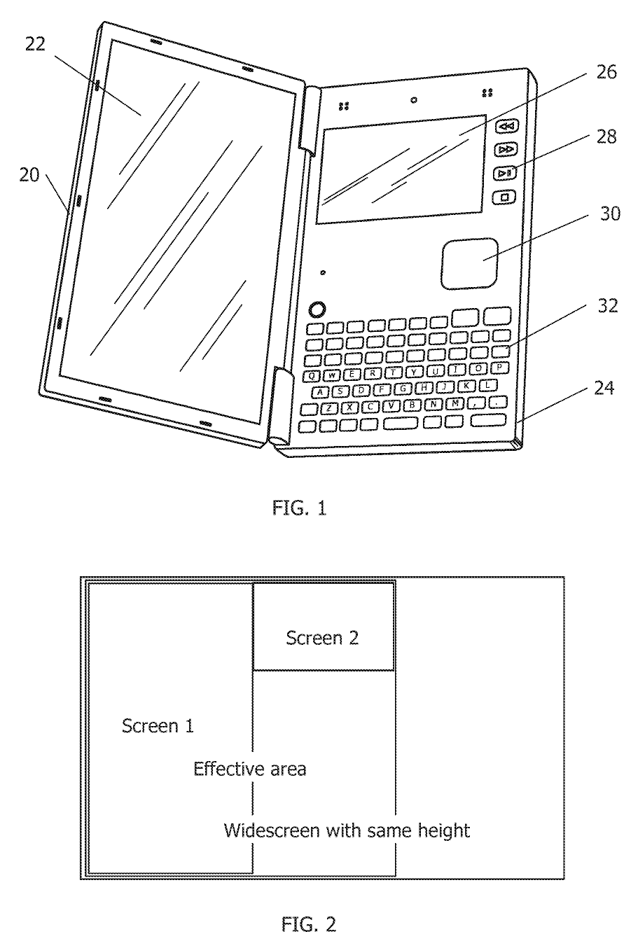

FIG. 1 shows the portable computer of the present invention. The first display screen 20 is located on one panel 22 of the computer, and on another panel 24 is the second display screen 26. For the second display screen 26, there are control buttons 28 to directly control the functions, especially for replay of video contents. The control buttons 28 typically include a “fast forward” button, a “fast backward” button, a “play and pause” button and a “stop” button. The control buttons 28 can be configured to control the operation of the second display screen depending on the contents on display, or even used to control the operation of the first display screen when the second display screen is not in use. The control buttons 28, a point device 30, and a keyboard 32 are located along the perimeter of the second panel for convenient operation. The second panel may include other input and output devices, such as wired communication devices, wireless communication devices, USB ports, a camera, speakers, a microphone, and a headphone. The central processing unit and other computer hardware are also housed in the second panel. The two panels are pivotally connected so that the two panels can be folded together. The two panels can be open either vertically as shown in FIG. 1 or horizontally like a typical notebook computer. There are other ways to physically connect the two panels. For example, the two panels can be connected like a board book with flexible materials at the connection. The flexible materials can be natural materials like leather and clothes or synthetic fabric or sheet materials. The two panels can also be attached by a sliding mechanism between a open position and a closed position. Still another way to attach the two panels is a rotation mechanism with a rotating axis perpendicular to the panel surface so that the upper panel can rotate 180 degrees from a closed position to a open position. The connection mechanisms used for mobile phones can also be adapted for the present invention.

The advantages of the two screen arrangement in the present invention is illustrated in FIG. 2. The first advantage is the increase of the effective display area. In other words, instead of a single large display screen, the two display screens can perform the same functions with less physical display area. Therefore, the physical size of the display screen can be kept small for better portability and the effective display area is large enough for better functionality. The effective screen size is the rectangle enclosing the two display screen. If the second display screen is too small, the percentage increase is too small to justify the cost for a second display screen. If the two display screens are the same or have the same height, there is no increase in the effective display area. This is the case for the Nintendo DS® game device, where there are two 3-inch screens. Preferably, the first display screen is in a portrait format and the second display screen is in a landscape format. The optimum size for the second display screen can be calculated from the aspect ratio of the screens. The common aspect ratios are 3:4, 9:16 (widescreen) and 10:16 (computer widescreen). The diagonal dimension is commonly used to measure the size of a display screen. For the maximum percentage increase of the effective display area, the diagonal size range for the second display screen generally is between 50% to 60% of the first display screen. Since the percentage increase is a slow changing function near the maximum point, and the range can be extended to 40% to 70% with the percentage increase only slightly changed from the maximum value (about 2%). Generally, the diagonal size of the second display screen can be chosen as 40% to 70% of the diagonal size of the first display screen.

As the physical area of the two screens is less than the effective display area, the energy consumption for display is reduced. In addition, the two screens can be controlled independently to enter into standby mode or off mode when not in active use. This further reduces the energy consumption for display. In a extreme case of only the second screen in use, the energy consumption can be as low as around 15%.

The arrangement of one display screen in a portrait format and the other display screen in a landscape format further makes effective use of the display area. The human reading habit prefers the portrait format for text. The text of a large magazine or newspaper is divided into narrow vertical columns for better reading. Normally the display screens for computers are in the landscape format. This is not a problem for display screens larger than 19 inches. For smaller display screens of portable computers people need to move up and down the page to see the whole document. The problem becomes annoying for screens less than 10.5 inches. The portrait format of the first display screen better accommodates the viewing of documents, and the landscape format of the second display screen is better for viewing of pictures and videos. To view a document with the same height in a single display screen, a much larger size is needed as shown by the largest rectangle in FIG. 2.

One embodiment of the present invention is a “pocketbook” portable computer. The panel dimensions for the pocketbook are about 104 mm by 172 mm, or the size of a typical pocket book. The first display screen is about 88 mm by 156 mm, and the second display screen is about 75 mm by 47 mm. The approximate numbers of dimensions are given in the specification by such words like “about” and “approximate”, and the values can generally be varied within plus or minus 11.2%. For example, the dimensions will change up to 11.1% between a 9:16 aspect ratio and a 10:16 aspect ratio. The first screen display, in the portrait format, is a 7-inch widescreen in the aspect ratio of 9:16. The second display screen, in the landscape format, is a 3.5-inch widescreen in the aspect ratio of 10:16. The diagonal size of the second display screen is 50% of the diagonal size of the first display screen. The effective display area, equivalent to a 9.3-inch widescreen, is increased by 48% than the actual physical display area. The height of the first screen is equivalent to a 11.5-inch widescreen. The display of the pocketbook is better than a typical netbook of 8.9-inch screen, while the pocketbook is small enough to fit into a pocket and consumes less energy for display. The 3.5-inch display screen is fair for viewing video clips, and the 7-inch display screen is good for personal viewing of movies. The dimensions and arrangement of the panels, the display screens, the keyboard, the control buttons, and the pointing device, are chosen for better ergonomical performance and aesthetic appearance. The pocketbook is ideal for checking emails, browsing the web, having a chat, viewing a video, and leisurely reading newspaper, magazine and books.

Another embodiment of the present invention is a “buzbook” portable computer. The panel dimensions for the buzbook are about 210 mm by 279 mm, about the size of a letter size paper (216 mm by 279 mm) or A4 paper (210 mm by 297 mm). The first display screen is about 171 mm by 254 mm, and the second display screen is about 140 mm by 87 mm. The first screen display is in the portrait format and is about 12.1 inches diagonally. The second display screen, in the landscape format, is a 6.5-inch widescreen in the aspect ratio of 10:16. The diagonal size of the second display screen is about 54% of the diagonal size of the first display screen. The effective display area, equivalent to a 16.5-inch widescreen, is increased by 42% than the actual physical display area. The height of the first screen is equivalent to a 18.9-inch widescreen. The buzbook is a versatile portable computer. The first display screen can display all common document and magazine pages in whole. The 6.5-inch widescreen provides comfortable personal viewing experience of videos and movies. The buzbook is a all-purpose portable computer for business people and students. For business, the buzbook can be used to carry relevant handbooks, reference materials, and corporate documents. For a student, the buzbook can hold all his the textbooks and assignments.

The common computer operating systems today, such as Windows XP®, Windows Vista®, and Linux®, can accommodate multiple display screens. In Windows XP, simply plug a monitor into the external VGA port of the notebook computer or use a USB video adapter, and then enable the Dualview feature of Windows XP. With Dualview enabled, the cursor and windows can be dragged between the display screens. Adding an additional monitor is a known technique to increase workspace. For example, U.S. Pat. Nos. 5,673,170, 5,768,096, 6,094,341, 6,222,507, 6,859,219, 7,289,083 and 7,375,954 disclose various ways to add physical display screens. The present invention is to increase the effective display area without a corresponding increase in the physical display area.

The software can specially take advantage of the two screen arrangement for better performance. The software can configured to automatically fit the content to the specific format of the pocketbook and buzbook. For a newspaper or magazine article, the first display screen can be used for the text, and the second display screen can be used for any associated pictures or videos. Or the second display screen can be used to display an advertisement. For a book, the second display screen can show the table of contents, while the first display screen shows a page. In a map application, the first display screen can show a detailed map while the second display screen shows the general orientation, and one can select in the second display screen the area of interest to be shown in the first display screen. In a form application, the first display screen can show the instruction and the second display screen can show the form. In an email application, the second display screen can show the list of mails, and the first display screen can show the selected email. One can have a cooking recipe on the first display screen, and the associated video instruction on the second display screen.

The second display screen can be a touch screen for easy input. A stylus can be used for input. This is very useful for note taking and field work. A project inspector can show the related items on the first display screen and put comments on the second display screen. A doctor or nurse can have the patient history on the first display screen and make entries on the second display screen.

Electronic paper has been used for display recently. One type of products using electronic paper is e-book readers, such as Amazon Kindle®, Sony PRS-700 Reader®, and iRex iliad®. Electronic paper is a display technology designed to mimic the appearance of ordinary ink on paper. Unlike a conventional flat panel display, which uses a backlight to illuminate its pixels, electronic paper reflects light like ordinary paper and is capable of holding text and images indefinitely without drawing electricity. Since electronic paper uses reflected ambient light, it has a wide viewing angle and it is viewable in bright light. Therefore, electronic paper is considered more comfortable to read than conventional displays. But at present electronic paper technologies have a very low refresh rate comparing with LCD technologies. Electronic paper can be used for the first display screen but LCD can be used for the second display screen. This combines the advantages of both technologies for better reading comfort and significant energy saving.

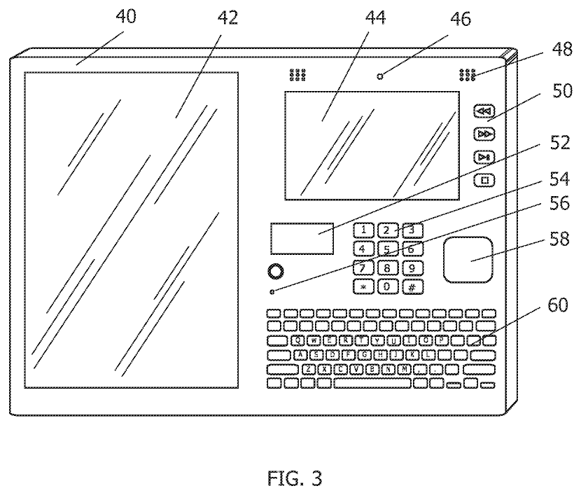

FIG. 3 shows the single panel computer “panelbook” of the present invention. A single panel 40 houses the first display screen 42 and the second display screen 44. Also housed in the single panel 40 are a video camera 46, speakers 48, control buttons 50 to directly control the functions of the second display screen 44, a status window 52, a number pad 54, a microphone 56, a point device 58, and a keyboard 60. At the back are power connection and communication ports (not shown). The dimensions of the display screens can be similar to the dimensions of the display screens of the buzbook. The first display screen 42 can be electronic paper. This computer can be used as a universal communication computer since text document, video, and voice work together. Such combination makes communication more effective. It can be placed at the desk with a stand like a picture frame. It can be mounted on the wall. It can be used as an information bulletin at public places like airports, railway stations, hospitals, shopping stores, libraries, hotels, restaurants, meeting places, and office hallways. The information can be easily updated from a central location and the communication can be interactive. For example, as an airport information bulletin, the first display screen can show the flight information. A passenger can type in a specific flight number, and the related information is shown. If he has a more specific question, he can be connected to a staff by the video and voice communication. He may choose his own language. A small staff at the information desk can handle requests from different locations at the airport. Information bulletins at a university campus or a corporate campus can quickly broadcast emergency messages or other notices.

The computers described in the present invention are also communication devices. A communication device may have a device identity, or the serial number given by the manufacturer. It may have a physical communication identity, such as the phone number or IP address in a communication network. This physical communication identity can be fixed or transient for just a session. To further increase the functions of communication networks, a user identity or ownership identity is needed. U.S. Pat. No. 6,744,874, Method of universal communication and devices thereof, by Wu, teaches a method to establish a user identity, which is herein incorporated by reference. A digital signature with a pair of private key and public key is used for identity purpose for a user number. The private key is kept in a personal communication controller. The user number and the public key is available at a database. The user can use the personal communication controller to lock the identity (preferably the public key of the identity) into a physical device or a document (digital file). When access is needed for the physical device or the document, the user is prompted to sign something with the personal communication controller. The digital signature is compared to allow or deny access. The identity is a live identity. In other words, it is unique in the communication networks, otherwise a conflict of identity will be detected.

When a device is locked to the digital identity of a user, it can only be opened by the user with his personal communication controller. This provides a security for the physical device. Secondary identities can also be created for a physical device. For example, a primary identity may be the personal identity of the user such as “John Doe”, and a secondary identity may be the identity of his company such as “XYZ Company”. If both identities are used, it means “John Doe of XYZ Company”. Of course, a computer can be left without a user identity, or in the anonymous state. The identity feature can be turned on or off as needed. When a user identity is present in a communication device, a people-oriented universal communication is feasible since the user identity has been verified. In a member only web application, members can automatically access the content without additional login procedures. In an email, the sender is authenticated. This allows a fee-based email service. A small charge of 2 cents to 5 cents per email would effectively curtail the problem of email spams. In a phone call, the caller is positively identified. The personal communication controller can be used as a phone at the vicinity of the computer through the physical connection of the computer to the network. For example, the panelbook at offices or as information bulletins at public places, are also communication connection points for the personal communication controller as a phone.

When a book, a magazine, a song, a movie, or other copyrighted material is sold to the user, the identity of the user is embedded to the digital file of the copyrighted material or a permission file associated with the material. The copyright owner will digitally sign the file or a digest of the file along with the user identity and other related information. The copyright management software can check the authenticity of the digital file. The copyright management software will check the identity of the user of the physical device, and the identity from the digital file or associated permission file. If the two identities match, then the file will be opened for display. Otherwise the user will be prompted to provide the correct identity from his personal communication controller. The copyright management software compares the identity of the user (public key) and a digital signature from the personal communication controller, and access is allowed if they are compatible. This copyright management method does not need access to the database of the copyright owner. The user is free to use the digital files on all his physical devices. The user can also use physical devices of other people to show the content at his presence.

The prior art copyright management software is either too restrictive by limiting the number of physical devices for access, or too intrusive by verifying the identity from a database for each access to the material. Many member-only web applications require password for access, and it is burdensome to remember so many passwords. The people-oriented universal communication system provides a user friendly copyright management and identity verification method. The portable computers in the present invention provide the convenient physical devices. This will make reading newspaper and magazine on the display screen more convenient and comfortable than in paper form. In the future, news media, publications, and communications will likely use text, picture, audio, and video in all possible combinations when appropriate for a specific occasion. The computer devices of the present invention provide the convenient tools for the widespread applications of multimedia news, publications, and communications.

Other embodiments of the invention will be apparent to those skilled in the art from a consideration of this specification or practice of the invention disclosed herein. It is intended that the specification and examples shall be interpreted as illustrative and not in a limiting sense, with the true scope and spirit of the invention being indicated by the following claims.

1. A portable computer, comprising:
a first display screen in the portrait format housed in a first panel;
a second display screen in the landscape format housed in a second panel, said second panel is physically attached to said first panel, the diagonal size of said second display screen is 40% to 70% of the diagonal size of said first display screen;
whereby the effective size of the display area is larger than the physical area of the display screens, and said portable computer can have small size, light weight, and long battery life.

2. The portable computer according to claim 1, wherein said first display screen is an electronic paper display.

3. The portable computer according to claim 1, wherein said second display screen is controlled by buttons for video play.

4. The portable computer according to claim 1, wherein said second display screen is a touch screen.

5. The portable computer according to claim 1, wherein first display screen is about 88 mm by 156 mm, and said second display screen is about 75 mm by 47 mm;
whereby said portable computer has the approximate dimensions of a pocket book in a closed position.

6. The portable computer according to claim 1, wherein first display screen is about 171 mm by 254 mm, and said second display screen is about 140 mm by 87 mm;
whereby said portable computer has the approximate dimensions of a letter size paper in a closed position.

7. The portable computer according to claim 1, wherein said portable computer is digitally locked to the identity of the user;
whereby copyrighted materials can be viewed on said display screens when the identity of said computer matches the user identity for the copyrighted materials.

8. The portable computer according to claim 1, further comprising:
control buttons for said second display screen;
a pointing device;
a keyboard;
said control buttons, said pointed device, and said keyboard located along the perimeter of said second panel;
whereby an ergonomical design is provided for easy access.

9. A method for increasing the effective display area of a computer, comprising:
providing a first display screen in the portrait format;
providing a second display screen in the landscape format;
said first display screen and said second display screen housed in a physically attached structure, and the diagonal size of said second display screen is 40% to 70% of the diagonal size of said first display screen;
whereby the display functionality is enhanced and the power consumption for display is reduced.
